(19) United States
(12) Patent Application Publication
(10) Pub. No.: US 2026/0128855 A1
(43) Pub. Date: May 7, 2026

(54) ELECTRONIC DEVICE AND CONTROLLING METHOD THEREOF

(71) Applicant: CRYPTO LAB INC., Seoul (KR)

(72) Inventors: Guillaume Hanrot, Seoul (KR); Damien Stehle, Seoul (KR)

(21) Appl. No.: 19/336,892

(22) Filed: Sep. 23, 2025

(30) Foreign Application Priority Data
Sep. 23, 2024 (KR) 10-2024-0128104
Oct. 2, 2024 (KR) 10-2024-0134251
Sep. 22, 2025 (KR) 10-2025-0136321

(51) Int. Cl. H04L 9/00; H04L 9/06; H04L 9/08

(52) U.S. Cl. CPC H04L 9/008; H04L 9/0631; H04L 9/0819

(57) ABSTRACT

An electronic apparatus and a controlling method thereof are disclosed. Specifically, the electronic apparatus includes memory storing instructions, and a processor configured to execute the instructions, and the processor is configured to obtain a complex root of unity data by transforming coefficient data included in an encrypted input ciphertext, obtain a plurality of plaintexts that encode the complex root of unity data in slots based on the complex root of unity data, obtain corrected ciphertexts by applying an encrypted mask and a complex conjugation operation to the plurality of plaintexts, obtain a plurality of rotation results of the corrected ciphertexts based on secret indices corresponding to each of a plurality of valid coefficients of a secret key, obtain an intermediate ciphertext based on the plurality of rotation results, and obtain an output ciphertext that is represented as a modulus value greater than a modulus value of an input ciphertext by performing a complex conjugation operation on the intermediate ciphertext and adding the result thereof to the intermediate ciphertext, and that is decodable with a plaintext vector corresponding to a decoding result of the input ciphertext.

### TECHNICAL FIELD

The disclosure relates to an electronic apparatus and a controlling method of the electronic apparatus, and more particularly to an electronic apparatus capable of performing bootstrapping and encryption operation, and a controlling method thereof.

### BACKGROUND ART

Homomorphic encryption may be an encryption scheme with which addition and multiplication operations can be performed in a ciphertext state, which makes operations possible without decoding sensitive data, and is receiving attention from various fields such as machine learning, statistical analysis, finance, and health care in which protection of privacy is required.

The Cheon-Kim-Kim-Song (CKKS) scheme may be the representative homomorphic encryption scheme that supports approximation operations for complex vectors, and utilization thereof in numerical operation applications such as machine learning and data analysis may be high. However, if repetitive multiplication operations are performed in the CKKS, noise may be significantly accumulated in a ciphertext, and after operations of a certain level or more, problems such as not being able to obtain correct results when performing decoding may occur.

To solve the above, a bootstrapping technique was introduced, but the conventional technique requires very high operation complexity and deep multiplicative depth, and has limitations of increasing delays in overall bootstrapping and excessive resource consumption.

In addition, because a stable operation in the conventional technique is possible only when a large modulus chain and ring degree are set, a parameter size of an entire system may become excessive. As a result, there may be limitations of an actual throughput reducing and required amount of memory increasing. The above may be factors that reduce practicalities of bootstrapping in, specifically, a cloud environment or devices with resource limitations.

Furthermore, the conventional technique requires unnecessary number of operations in a rotation operation and masking process, and a deterioration in performance of the overall bootstrapping may occur due to not effectively managing a modulus budget.

Accordingly, in order to effectively perform CKKS bootstrapping, a new approach for reducing complexities in existing levels, and simultaneously minimizing operation depth and modulus consumption is needed.

### DISCLOSURE

### Technical Solution

Aspects according to the disclosure are provided to solve at least the above-described problems, and to provide an electronic apparatus capable of performing efficient and effective bootstrapping and encryption operations and a controlling method thereof.

Additional aspects will be described in part in the description below, and parts thereof will be obvious from the description, or learned by practice of the embodiments provided.

According to an aspect of the disclosure, an electronic apparatus includes memory storing instructions, and a processor configured to execute the instructions, and the processor is configured to obtain the complex root of unity data by transforming coefficient data included in an encrypted input ciphertext, obtain a plurality of plaintexts that encode the complex root of unity data in slots based on the complex root of unity data, obtain corrected ciphertexts by applying an encrypted mask and a complex conjugation operation to the plurality of plaintexts, obtain a plurality of rotation results of the corrected ciphertexts based on secret indices corresponding to each of a plurality of valid coefficients of a secret key, obtain an intermediate ciphertext based on the plurality of rotation results, and obtain an output ciphertext that is represented as a modulus value greater than a modulus value of an input ciphertext by performing a complex conjugation operation on the intermediate ciphertext and adding the result thereof to the intermediate ciphertext, and that is decodable with a plaintext vector corresponding to a decoding result of the input ciphertext.

The processor may be configured to obtain an output ciphertext by applying a correction coefficient to at least one from among the plurality of plaintexts or at least one from among the corrected ciphertexts.

The processor may be configured to obtain an output ciphertext by having at least one from among the plurality of plaintexts omit application of the encrypted mask and the complex conjugation operation.

The processor may be configured to transform the input ciphertext to the complex root of unity data, and after encoding the complex root of unity data to plaintext data on a slot basis, increase a modulus value of the plaintext data.

The processor may be configured to obtain the plurality of rotation results by performing a blind rotation in parallel based on the secret indices.

The processor may be configured to perform at least one from among a sum of a plurality of simple homomorphic rotation operations multiplied by ciphertexts provided as a part of the blind rotation and one or more multiplexer-based rotation operations that use a plurality of keys which is provided as a part of the blind rotations.

The processor may be configured to perform, based on a range of the secret index being less than or equal to a predetermined threshold value, the simple homomorphic rotation, and perform, based on a range of the secret index exceeding the threshold value, the multiplexer based rotation.

The processor may be configured to reduce a number of valid coefficients by using a secret-sparse secret key in a process of obtaining the plurality of rotation results.

The processor may be configured to obtain the plurality of rotation results after increasing a modulus value of the input ciphertext.

According to an aspect of the disclosure, a method for controlling an electronic apparatus includes obtaining the complex root of unity data by transforming coefficient data included in an encrypted input ciphertext, obtaining a plurality of plaintexts that encode the complex root of unity data in slots based on the complex root of unity data, obtaining corrected ciphertexts by applying an encrypted mask and a complex conjugation operation to the plurality of plaintexts, obtaining a plurality of rotation results of the corrected ciphertexts based on secret indices corresponding to each of a plurality of valid coefficients of a secret key, obtaining an intermediate ciphertext based on the plurality of rotation results, and obtaining an output ciphertext that is represented as a modulus value greater than a modulus value of an input ciphertext by performing a complex conjugation operation on the intermediate ciphertext and adding the result thereof to the intermediate ciphertext, and that is decodable with a plaintext vector corresponding to a decoding result of the input ciphertext.

According to an aspect of the disclosure, a non-transitory computer-readable medium configured to store a program, the program configured to execute a method for controlling an electronic apparatus, and the method including obtaining the complex root of unity data by transforming coefficient data included in an encrypted input ciphertext, obtaining a plurality of plaintexts that encode the complex root of unity data in slots based on the complex root of unity data, obtaining corrected ciphertexts by applying an encrypted mask and a complex conjugation operation to the plurality of plaintexts, obtaining a plurality of rotation results of the corrected ciphertexts based on secret indices corresponding to each of a plurality of valid coefficients of a secret key, obtaining an intermediate ciphertext based on the plurality of rotation results, and obtaining an output ciphertext that is represented as a modulus value greater than a modulus value of an input ciphertext by performing a complex conjugation operation on the intermediate ciphertext and adding the result thereof to the intermediate ciphertext, and that is decodable with a plaintext vector corresponding to a decoding result of the input ciphertext.

### DESCRIPTION OF DRAWINGS

Aspects above and other aspects, features, and advantages according to the disclosure will be made clearer from the following detailed description taken in together with the accompanying drawings.

FIG. 1 is a block diagram illustrating in brief a configuration of an electronic apparatus according to an embodiment of the disclosure;

FIG. 2 is a block diagram illustrating a plurality of modules according to an embodiment of the disclosure; and

FIG. 3 is a flowchart illustrating a controlling method of an electronic apparatus according to an embodiment of the disclosure.

### MODE FOR INVENTION

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include all modifications, equivalents or alternatives of the embodiments included in the ideas and the technical scopes disclosed herein. With respect to the description of the drawings, like reference numerals may be used to indicate like elements.

In describing the disclosure, in case it is determined that the detailed description of related known technologies or configurations may unnecessarily confuse the gist of the disclosure, the detailed description thereof will be omitted.

Further, the embodiments below may be modified to various different forms, and it is to be understood that the scope of the technical spirit of the disclosure is not limited to the embodiments below. Rather, the embodiments are provided so that the disclosure will be thorough and complete, and to fully convey the technical spirit of the disclosure to those skilled in the art.

Terms used in the disclosure have been merely used to describe a specific embodiment, and is not intended to limit the scope of protection. A singular expression includes a plural expression, unless otherwise specified.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

In the disclosure, expressions such as “A or B”, “at least one of A and/or B”, or “one or more of A and/or B” may include all possible combinations of the items listed together. For example, “A or B”, “at least one of A and B”, or “at least one of A or B” may refer to all cases including (1) at least one A, (2) at least one B, or (3) both of at least one A and at least one B.

Expressions such as “1st”, “2nd”, “first”, or “second” used in the disclosure may limit various elements regardless of order and/or importance, and may be used merely to distinguish one element from another element and not limit the relevant elements.

When a certain element (e.g., first element) is indicated as being “(operatively or communicatively) coupled with/to” or “connected to” another element (e.g., second element), it may be understood as the certain element being directly coupled with/to the another element or as being coupled through other element (e.g., third element).

Conversely, when the certain element (e.g., first element) is indicated as “directly coupled with/to” or “directly connected to” the another element (e.g., second element), it may be understood as the other element (e.g., third element) not being present between the certain element and the another element.

The expression “configured to . . . (or set up to)” used in the disclosure may be used interchangeably with, for example, “suitable for . . . ”, “having the capacity to . . . ”, “designed to . . . ”, “adapted to . . . ”, “made to . . . ”, or “capable of . . . ” based on circumstance. The term “configured to . . . (or set up to)” may not necessarily mean “specifically designed to” in terms of hardware.

Rather, in a certain circumstance, the expression “a device configured to . . . ” may mean something that the device “may perform . . . ” together with another device or components. For example, a phrase “a processor configured to (or set up to) perform A, B, and C” may mean a dedicated processor (e.g., an embedded processor) for performing a relevant operation, or a generic-purpose processor (e.g., a central processing unit (CPU) or an application processor) capable of performing the relevant operations by executing one or more software programs stored in a memory device.

The term ‘module’ or ‘part’ used in the embodiments herein perform at least one function or operation, and may be implemented with hardware or software, or implemented with a combination of hardware and software. In addition, a plurality of ‘modules’ or a plurality of ‘parts', except for a 'module’ or a ‘part’ which needs to be implemented with a specific hardware, may be integrated in at least one module and implemented as at least one processor.

Meanwhile, various elements and areas in the drawings have been schematically illustrated. Accordingly, the technical spirit of the disclosure is not limited by relative sizes and distances illustrated in the accompanied drawings.

Embodiments of the disclosure will be described in detail below with reference to the accompanying drawings to aid in the understanding of those of ordinary skill in the art.

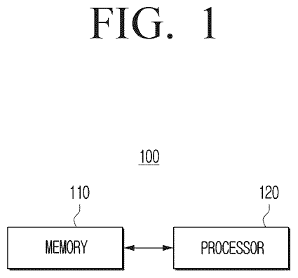

FIG. 1 is a block diagram illustrating a configuration of an electronic apparatus 100 according to an embodiment of the disclosure.

As shown in FIG. 1, the electronic apparatus 100 may include a memory 110 and a processor 120. However, the configurations as shown in FIG. 1 are merely examples, and a new configuration may be added or a portion of the configuration may be omitted in addition to the configurations as shown in FIG. 1 when implementing the disclosure. For example, the electronic apparatus 100 may further include a communication interface (WiFi module, Bluetooth module, wireless communication module, NFC module, Ultra-Wide Band (UWB) module, etc.) capable of performing communication with an external device, an input interface (e.g., microphone, touch screen, etc.) for receiving a user input, an output interface (e.g., display, speaker, etc.) capable of outputting various information, and the like.

The memory 110 may be stored with at least one instruction with respect to the electronic apparatus 100. Further, the memory 110 may be stored with an operating system (O/S) for driving the electronic apparatus 100. In addition, the memory 110 may be stored with various software programs or applications for the electronic apparatus 100 to operate according to various embodiments of the disclosure. Further, the memory 110 may include a semiconductor memory such as a flash memory, a magnetic storage medium such as a hard disk, or the like.

Specifically, the memory 110 may be stored with various software modules for the electronic apparatus 100 to operate according to the various embodiments of the disclosure, and the processor 120 may control an operation of the electronic apparatus 100 by executing various software modules stored in the memory 110. In other words, the memory 110 may be accessed by the processor 120, and reading, writing, modifying, deleting, updating, and the like of data may be performed by the processor 120.

Meanwhile, the term ‘memory 110’ in the disclosure may be used as a meaning that includes the memory 110, a ROM within the processor 120, a RAM, or a memory card (e.g., micro SD card, memory stick) mounted to the electronic apparatus 100.

According to an embodiment, in the memory 110, information about an input ciphertext, an intermediate ciphertext, an output ciphertext, an encryption scheme (e.g., CKKS), and the like according to the disclosure may be stored. In the memory 110, various algorithms for performing an operation according to the disclosure may be stored. In addition thereto, various information necessary within an extent for achieving an object of the disclosure may be stored in the memory 110, and the information stored in the memory 110 may be received from an external device or updated based on being input by a user.

The processor 120 may control the overall operation of the electronic apparatus 100. Specifically, the processor 120 may be connected with configurations of the electronic apparatus 100 including the memory 110. The processor 120 may include a processing circuit, and may be implemented as at least one processor 120. In other words, the processor 120 may be implemented as one processor 120 or two or more processors 120. The processor 120 may control, by individually or collectively executing instructions stored in the memory 110, an operation of the electronic apparatus 100.

The processor 120 may be implemented with various schemes. For example, the processor 120 may be implemented as at least one from among an application specific integrated circuit (ASIC), an embedded processor, a microprocessor, a hardware control logic, a hardware finite state machine (FSM), and a digital signal processor (DSP). Meanwhile, the term ‘processor 120’ in the disclosure may be used as a meaning which includes a central processing unit (CPU), a graphic processing unit (GPU), a main processing unit (MPU), and the like.

In various embodiments, the processor 120 may transform, in performing bootstrapping with respect to an encrypted input ciphertext, coefficient data to a complex root of unity data, apply modulus raising, and by dynamically assessing a decoding equation according to a modulus, an output ciphertext that includes a plaintext vector corresponding to the input ciphertext may be effectively and stably obtained. The main concept will be described first briefly below and then, various embodiments implemented by the processor 120 will be described.

The ciphertext according to the disclosure may refer to a result of having encrypted a plaintext according to a homomorphic encryption scheme. The ciphertext according to the disclosure may include an input ciphertext, an intermediate ciphertext, an output ciphertext, and the like as described below, and the ciphertexts described above may indicate a result of having performed encryption with the same homomorphic encryption scheme.

According to an embodiment, the input ciphertext, the intermediate ciphertext, and the output ciphertext may be encrypted based on the homomorphic encryption scheme for approximately performing an addition and multiplication operation while real data and complex data are encrypted. In other words, the ciphertexts according to the disclosure may include the Cheong-Kim-Kim-Song (CKKS) encryption scheme which is a homomorphic encryption scheme for a complex approximation operation. However, the ciphertext according to the disclosure is not limited to the CKKS ciphertext, and may be applied to other homomorphic encryption schemes.

The ‘bootstrapping’ may refer to an operation for removing noise accumulated in the ciphertext, or restoring a size of a modulus. In addition, the bootstrapping may remove noise that is accumulated as operations are repeated in the homomorphic encryption scheme, and may be referred to as a scheme for restoring the ciphertext back to an operable state.

The bootstrapping may be for restoring multiplicative depth. The multiplicative depth may indicate how many times the multiplication operation can be repeatedly performed in the homomorphic encryption, in other words, a depth of ciphertext with which the multiplication operation can be performed, and typically, noise that is accumulated in the ciphertext may be increased the more the multiplication operation is performed over several times. Furthermore, when noise of a certain level or more is accumulated, a more accurate calculation may not be possible. Bootstrapping allows for continuous multiplication operations within the ciphertext to be possible, and may mean a process of guaranteeing accuracy in an operation by removing noise which can be generated in an operation and restoring.

A bootstrapping process according to the disclosure may consist of a series of levels that typically include transforming an input ciphertext into different representation spaces from one another, enlarging/reducing a size of a modulus, and applying an exponential function approximation operation. Specifically, the bootstrapping process may include a StoC and ModRaise process.

A Slot-to-Coefficient (StoC) transformation may refer to a process of transforming slot unit data (slot data) included in the input ciphertext to coefficient data. Through the above, information scattered across operations for each slot may be integrated into a coefficient based polynomial representation. The StoC may function as a pre-processing level for applying the modulus raising (ModRaise) thereafter.

The modulus raising (ModRaise) may refer to a process of increasing a modulus value of a ciphertext. Through the above, the processor 120 may prepare the ciphertext to absorb scale consumption and noise increase which can generate in an exponential function approximation operation (EvalExp) following thereafter. Increasing the modulus may not only be the main objective of bootstrapping, but the scale consumption in the bootstrapping level itself may be a price that has to be paid in order to achieve the above.

The processor 120 may obtain the complex root of unity data by transforming the coefficient data included in the encrypted input ciphertext. The transformation process described above may be a process performed with respect to a public representation of a ciphertext formed with two plaintext components rather than a homomorphic operation, and the plaintext may be returned as a result thereof.

The input ciphertext according to the disclosure may mean a result obtained from an external device according to a homomorphic encryption scheme or a result of having encrypted plaintext data obtained from an internal operation. The input ciphertext may be an initial ciphertext for a subsequent operation, and may internally include polynomial coefficient data. Here, the coefficient data may mean a numerical value corresponding to each term of a polynomial represented by the ciphertext, and may mean a basic unit of information included in the ciphertext.

The ‘complex root of unity data’ may refer to an intermediate result obtained as coefficient data included in the input ciphertext is transformed, and may consist of a set of complex number values that are positioned at a unit circle on a complex plane. The complex root of unity may be represented in an exp(2πim/t) form, and here, ‘e’ may be a natural constant, ‘i’ may be an imaginary unit, and ‘m’ may be an integer value included in the coefficient data. As an example, ‘t’may be a ciphertext modulus at a ModRaise time-point.

In an embodiment, the processor 120 may stably obtain the complex root of unity data by increasing the modulus value after transforming the input ciphertext to slot data. The transformation to slot data makes it possible to perform a parallel operation by vectorizing an internal representation of the ciphertext, and the increase of modulus value may perform a role of maintaining an operation precision level when applying an approximation polynomial of an exponential function in a subsequent operation. A series of operations as described may be specified as a process that transforms the input ciphertext to the complex root of unity data and then, encodes the same in plaintext data on a slot basis, and that increases the modulus value of the plaintext data.

Meanwhile, the transformation to the complex root of unity may be a process for generating plaintext, and there may not be a direct causal relationship with the modulus increasing (ModRaise). Accordingly, the modulus increasing may be considered in a process separate from the transformation to the complex root of unity.

In an embodiment, the processor 120 may separate or store, rather than simply stopping at transforming the coefficient data included in the input ciphertext, the coefficient data of the input ciphertext into an upper half and a lower half using the memory 110, and execute pre-processing of performing sign correction through a complex conjugation operation. A result of this level may be in a plaintext state rather than a ciphertext state. Then, by summing result ciphertexts after having multiplied an encrypted mask to the corresponding plaintext, and applying a modulus operation, pre-processed ciphertexts may be obtained. Through the pre-processing described, the processor 120 may improve the overall stability and throughput of bootstrapping by reducing unnecessary re-arrangements and error propagation in a rotation, masking, and multiplication tree level which will be performed hereafter.

The processor 120 may obtain a plurality of plaintexts that encode corresponding complex root of unity data in slots based on the complex root of unity data.

Here, the plaintext may refer to data operable in a non-encrypted state, and may be used as input of an encryption operation or a correction operation in a subsequent level. The slot may refer to individual storing positions that consist the plaintext vector, and several slots may be disposed in one plaintext and support a vector operation.

In an embodiment, the processor 120 may enhance accuracy of an output ciphertext by applying at least one correction coefficient from among the plurality of plaintexts. A correction coefficient may be designed to supplement a numerical error that can occur in a transformation process of the complex root of unity data, and provide an effect of reducing operation depth by being applied in the plaintext level.

In an embodiment, the processor 120 may have at least one from among a plurality of plaintexts omit the application of the encrypted mask and the complex conjugation operation. Through the above, unnecessary operations may be reduced, a specific plaintext may be utilized as reference data, and the overall processing efficiency may be raised.

The processor 120 may obtain corrected ciphertexts by applying the encrypted mask and the complex conjugation operation in the plurality of plaintexts.

The corrected ciphertext may refer to a ciphertext that is transformed by a specific operation being applied to a plaintext so as to be suitable for a subsequent rotation operation and multiplication operation.

The mask may refer to an operation for selectively leaving only components corresponding to a specific position from among data for each slot in the plaintext and removing the remaining components. Specifically, the mask may be implemented with an element-wise multiplication with selected vectors for each slot, and through the above, the plaintext may be encrypted in an aligned state in a correct index. The encrypted mask may mean the selected vectors described being provided in an encrypted form, and a selective correction may be possible without additionally consuming operation depth through the multiplication operation with the ciphertext.

In addition, the complex conjugation operation may refer to a process of calculating and applying a conjugate of the complex root of unity data included in the plaintext. When the complex conjugation operation is applied, symmetry of the complex root of unity data is utilized and unnecessary terms may be removed or simplified. Thereby, an effect of reducing a degree of the polynomial and reducing an operation amount may be provided.

In an embodiment, the processor 120 may apply the encrypted mask with respect to each of the plurality of plaintexts for the slot to be aligned at positions corresponding to a rotation index. Then, by applying the complex conjugation operation, changes in signs (symbols, marks) and phases accompanied in the rotation may be matched, and a corrected ciphertext may be obtained as a result therefrom.

Accordingly, the corrected ciphertext obtained at this level may be used as input of a rotation operation that is based on a secret index thereafter, and may function as an intermediate output that guarantees accuracy and stability of the entire bootstrapping process.

The processor 120 may obtain, based on secret indices corresponding to each of a plurality of valid coefficients of a secret key, a plurality of rotation results of the corrected ciphertexts. A valid coefficient may refer to a coefficient (or secret key coefficient) that directly affects a rotation operation from among all secret key coefficients. The secret index may refer to an index that is referenced when performing a rotation operation corresponding to each valid coefficient, and may be provided in an operation in an encrypted state and processed so as to be not exposed to the outside.

A rotation result may refer to a ciphertext obtained due to the corrected ciphertext being rearranged based on the secret index. Specifically, data included in the corrected ciphertext is moved to a designated position by the secret index, and through the above, different rotation results may be generated. In other words, when secret indices corresponding to each valid coefficient are set, the processor 120 may obtain different rotation results by moving the complex root of unity data according to a ciphertext that includes a corresponding index representation.

In an embodiment, the processor 120 may obtain the plurality of rotation results by performing a blind rotation in parallel based on the secret indices. The blind rotation may refer to a scheme in which a rotation is performed while the rotation index is in an encrypted state, and through the above, the position and sign information of the secret key may not be exposed to the outside. In addition, because the blind rotation does not additionally consume multiplicative depth, an advantage of being able to effectively manage a modulus budget in the entire bootstrapping process may be provided.

In an embodiment, the processor 120 may implement the rotation operations in a form of doubly homomorphic rotations. The doubly homomorphic rotations may mean a process of homomorphically processing both the rotation operation itself and an index selection operation in a ciphertext state unlike the blind rotation that simply performs rotations while hiding an encrypted index. Accordingly, the processor 120 may not only generate correct rotation results even while the rotation index is in the encrypted state, but also simultaneously secure security and versatility by performing homomorphic operations until a selection/combination process of the corresponding rotation results. Meanwhile, the doubly homomorphic rotations may not stop at simply including security properties of the blind rotation, but may be understood as a more generalized concept by homomorphically processing even the selection and combination of the rotation results in the ciphertext state.

Specifically, the processor 120 may obtain the rotation results by performing at least one from among one or more multiplexer-based rotation operations that use the sum of a plurality of simple homomorphic rotation operations multiplied by the ciphertexts provided as a part of the blind rotation, and a plurality of keys provided as a part of the blind rotation. At this time, a simple homomorphic rotation may be effective in a small index range, and a multiplexer based rotation may perform rotations at a log complexity with respect to a large index range.

More specifically, the processor 120 may selectively perform a combination of one or two processes based on ciphertexts that represent various portions of the rotation index. For example, a first process may involve selecting from among a plurality of simple homomorphic rotation results multiplied by the ciphertext that represent a portion of the rotation index. The first process may be combined with the masking level described above and performed on not just the ciphertext, but also the plaintext, and a more improved throughput may be obtained through the above. For example, a second process may involve selecting one ciphertext from among the plurality of simple homomorphic rotation results using a specific multiplexing operation that represents a portion of the rotation index. The first process may be advantageous when the index range is narrow due to a relatively simple structure, and the second process may effectively generate the doubly homomorphic rotation results even when the index range is wide. The two processes described above may be combined into various schemes, and processes according to the disclosure are not limited to the two processes described above.

In an embodiment, the processor 120 may perform the simple homomorphic rotation if a range of the secret index less than or equal to a predetermined threshold value, and perform the multiplexer based rotation if the range exceeds the threshold value. Through the above, operation efficiency may be raised, and an optimized rotation result for each of the small index range and the large index range may be obtained. Specifically, in the small index range, the amount of calculation may be reduced with simple operations, and in the large index range, process efficiency may be improved through a multiplexing based approach. All doubly homomorphic rotations operations may be performed independent from one another or in parallel, and may be performed in parallel in not just an instance with a plurality of processors, but also in a multicore or multi-GPU environment.

In an embodiment, the processor 120 may use a secret-sparse secret key in the rotation process. The secret-sparse secret key may be configured to have a structural secret-sparsity by fixing a number of valid coefficients and a limitation condition of a secret key index and thereby, the number of valid coefficients that actually contribute to an operation may be reduced. Ultimately, the processor 120 may reduce the number of rotation results that has to be generated, and reduce operation load.

In an embodiment, the processor 120 may obtain the rotation result after first increasing a modulus value of the input ciphertext. In addition, the modulus increasing may be dynamically adjusted by combining a rotation index range with whether or not to apply the secret-sparse secret key, and through the above, an optimal operation environment of guaranteeing security and reducing relative error when performing various methods of blind rotation may be provided.

In an embodiment, the processor 120 may perform the doubly homomorphic rotation operations according to the blind rotation method based on indices embedded in a selected bit an evaluation key. The processor 120 may prevent position or sign information of the secret key from being exposed to the outside, and perform rotation by reducing consumption of a multiplication level according to design.

In an embodiment, the processor 120 may implement the blind rotation method with a column based method, a multiplexing based method, or a hybrid scheme thereof. The column based method may provide high parallelism and efficiency by depending on a simple CKKS operation such as a ciphertext-plaintext multiplication and a ciphertext-ciphertext addition. However, this method may linearly increase the cost of operation the bigger the rotation index range becomes. Conversely, the multiplexing based method may achieve log complexity with respect to the rotation index range by depending on a HMuxRot operator which determines rotation according to the selected bit, but sequential cost may be incurred due to key switching. Each method may have differences even in terms of modulus consumption properties. The multiplexing based method may be designed to minimize multiplicative depth consumption, and the column based method may save on the modulus budget by avoiding rescaling by utilizing an auxiliary modulus.

In an embodiment, the processor 120 may perform rotations with a scheme that selects one from among lower subsets of a subset selected from an upper level for each level by hierarchically decomposing an available set of rotation indices. At this time, an operation for selecting a single rotation in each level may be implemented by any one of the column based method or the multiplexing based method. It may be preferable to utilize the column based method from an uttermost level of a hierarchy structure for various reasons, and efficiency may be secured by applying the multiplexing based method in levels thereafter.

Ultimately, the plurality of rotation results obtained by the processor 120 may be maintained as intermediate data for operations thereafter. The order of the operations may proceed in the order of the complex conjugation operation, a masking and recombining, and the blind rotation.

In an embodiment, the processor 120 may first apply the complex conjugation operation with respect to the plurality of rotation results, and after having performed the masking and recombining thereafter, obtain the corrected result by applying the blind rotation. Here, the complex conjugation operation may mean calculating a conjugate of the complex root of unity data included in each rotation result. The masking may mean selectively maintaining only the position corresponding to the specific rotation index from among the plurality of rotation results, and removing other components, and may be implemented with an element-wise multiplication with the selected vector for each slot. In addition, in an embodiment, the masking and recombining level may be performed by combining with the column based blind rotation, and modulus consumption may be reduced through the above.

Through the configuration above, the processor 120 may reduce complexity of the rotation operation compared to conventional technology while maintaining the parallelism guaranteed in security, and enable efficient operations.

In an embodiment, processor 120 may apply a mask to the plurality of rotation results and obtain a result aligned at a position corresponding to the rotation index. In other words, the mask may rearrange each rotation result to match the corresponding index and reduce unnecessary operations in multiplication thereafter.

In an embodiment, the processor 120 may align/select the rotation result by applying a mask included in a bootstrapping key. The processor 120 may perform by applying the mask with the plaintext-ciphertext multiplication for each slot without additional consumption of multiplicative depth, and enhance correction accuracy by applying the complex conjugation operation in order to adjust changes in sign and phases that are accompanied in the rotations thereafter. The masking and aligning process described may be deployed after the blind rotation, but it may be preferable to perform the same before blind rotation from a usefulness and accuracy perspective.

The processor 120 may obtain the intermediate ciphertext based on the plurality of rotation results.

The intermediate ciphertext may refer to a ciphertext in an intermediate state in which the plurality of rotation results are combined and used as an input of a subsequent polynomial operation. The ciphertext described may be a result constituted in a form suitable to the polynomial approximation operation after the complex root of unity data that was transformed in the input ciphertext was rearranged through the correction process.

In an embodiment, the processor 120 may obtain the intermediate ciphertext by performing the multiplication operation after the plurality of rotation results is arranged in a binary tree structure. The binary tree structure may refer to a data structure configured to perform multiplication in levels by pairing two of each of a plurality of input data. By applying the above, a depth of the multiplication operation may increase in proportion to a number of input data, but may be limited in proportion to a log value of a number of data. Accordingly, it may be possible to prevent a multiplication operation route becoming unnecessarily longer while generating an efficient intermediate ciphertext.

In an embodiment, the processor 120 may obtain an intermediate ciphertext in which the multiplicative depth is proportionate to the log value for the number of valid coefficients by optimizing a multiplication order according to the binary tree structure. The process described above may reduce operation complexity, and mitigate noise accumulation in the ciphertext to guarantee safety of the subsequent operation.

Meanwhile, a portion of the ciphertexts included in the binary tree structure may follow a separate process without going through the blind rotation, masking or complex conjugation operation levels, and ciphertexts that follow the unusual route described above may be considered together therewith.

Further, the processor 120 may perform parallel processing in a multi-core environment. Accordingly, as the multiplication operation is performed simultaneously for each level of the tree, the overall operation time may be reduced, and the intermediate ciphertext may be obtained having higher efficiency and stability.

Accordingly, the intermediate ciphertext obtained at this level may function as key input for a polynomial operation of a subsequent level as an important intermediate output combined with the plurality of rotation results.

The processor 120 may perform the complex conjugation operation on the intermediate ciphertext, and by adding the result in the intermediate ciphertext, an output ciphertext may be obtained.

The output ciphertext may be represented in a modulus value greater than the modulus value of the input ciphertext, and may refer to a final ciphertext that is capable of stably restoring a plaintext vector corresponding to the input ciphertext in the decoding process.

The complex conjugation operation may refer to an operation for calculating and applying a conjugate of the complex root of unity data. The operation may remove or simplify an unnecessary term by utilizing symmetry on a complex plane, and provide an effect of reducing a degree of the polynomial and lowering operation complexity.

In an embodiment, the processor 120 may form, after applying the complex conjugation operation to the intermediate ciphertext, a finally stabilized output ciphertext by adding the result thereof back to the intermediate ciphertext. At this time, due to the intermediate ciphertext and the result of the complex conjugation operation being combined, changes in phase or changes to signs which may generate in the operation may be offset, and the output ciphertext may be corrected to match with the plaintext vector when decoding.

In an embodiment, the output ciphertext may be represented as a modulus value greater than the modulus value of the input ciphertext. The increase of modulus value may be designed to minimize error when performing decoding while maintaining the operation precision level, ultimately, stably obtain the plaintext vector corresponding to a decoding result of the input ciphertext.

Accordingly, the output ciphertext obtained at the present level may be a final output of the entire bootstrapping process, and may be a result of having transformed the input ciphertext to a stably decodable state in an expanded modulus environment.

As described above, according to the embodiments, the electronic apparatus 100 may reduce a depth of bootstrapping (e.g., CKKS bootstrapping) to a log level, and reduce the operation load and the modulus budget through optimizing the rotation operation and application of a sparse secret key. In addition, the electronic apparatus 100 may allow for an efficient operation while maintaining high accuracy through a binary tree multiplication. Ultimately, the electronic apparatus 100 may greatly enhance practicality of homomorphic encryption by reducing bootstrapping time delay and improving throughput.

In addition, the electronic apparatus 100 may strengthen security by preventing a position of the secret key or sign information from being exposed to the outside through the application of the blind rotation and the secret-sparse secret key. Moreover, through dynamic adjustment of modulus raising and multicore multi-GPU parallelization support, provide expandability and flexibility in various operation environments, and guarantee a more stable and precise decoding through a plaintext level correction and the complex conjugation operation. Furthermore, because the technical spirit of the disclosure is not only applicable to the CKKS scheme, but also to other homomorphic encryption schemes, versatility may be improved.

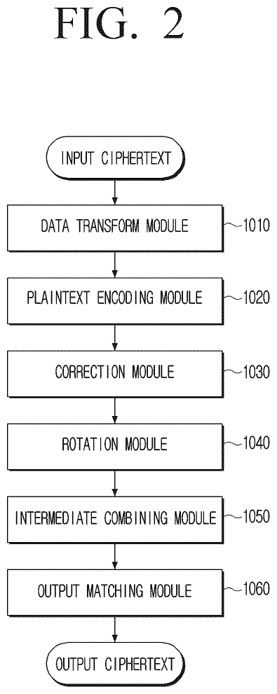

FIG. 2 is a block diagram illustrating a plurality of modules according to an embodiment of the disclosure.

As shown in FIG. 2, the plurality of modules may include a data transformation module 1010, a plaintext encoding module 1020, a correction module 1030, a rotation module 1040, an intermediate combining module 1050 and an output matching module 1060. The plurality of modules may be implemented with a software module or a hardware module, and a portion from among the plurality of modules may be implemented as a neural network model. Two or more modules from among the plurality of modules may be implemented as one integrated module. Various embodiments implementable by the processor 120 through the plurality of modules will be described below.

The processor 120 may transform, through the data transformation module 1010, coefficient data to complex root of unity data by transforming the coefficient data included in the encrypted input ciphertext. For example, the data transformation module 1010 may transform the coefficient data to the complex root of unity data by performing processes such as a slot-coefficient transformation and modulus raising by receiving the input ciphertext. In an embodiment, the data transformation module 1010 separate and store the coefficient data into an upper half and a lower half, and perform pre-processing of the sign correction through the complex conjugation operation.

The processor 120 may obtain, through the plaintext encoding module 1020, a plurality of plaintexts by encoding the complex root of unity data in a slot. The plaintext encoding module 1020 may configure plaintext vectors for each slot based on the complex root of unity data, and raise the operation precision level thereafter by applying the correction coefficient according to necessity.

The processor 120 may obtain, through the correction module 1030, the corrected ciphertext by applying the encrypted mask and the complex conjugation operation to the plurality of plaintexts. The correction module 1030 may reduce unnecessary operations by omitting the mask and the conjugate operation with respect to specific plaintexts, and perform a rotation index alignment and phase correction by applying the encrypted mask and the complex conjugation operation with respect to other plaintexts.

The processor 120 may obtain a plurality of rotation results by rotating the corrected ciphertext according to the secret index through the rotation module 1040. The rotation module 1040 may selectively perform at least one from among the simple homomorphic rotation and the multiplexer based rotation, and the secret index may be provided in an encrypted state and not exposed to the outside. In an embodiment, the rotation module 1040 may improve operation efficiency by calculating the plurality of rotation results in parallel.

The processor 120 may obtain the intermediate ciphertext by performing multiplication operations for each level by arranging the plurality of rotation results in the binary tree structure through the intermediate combining module 1050. The intermediate combining module 1050 may limit the multiplicative depth to the log level, and provide a stable intermediate ciphertext by reducing noise accumulation. In addition, a portion of the ciphertext may follow a separate process without going through the blind rotation, the masking, and the conjugate operation level, and the unusual route described may also be processed by the intermediate combining module 1050.

The processor 120 may obtain, through the output matching module 1060, the final output ciphertext by applying the complex conjugation operation to the intermediate ciphertext and adding the result thereof to the intermediate ciphertext. The output matching module 1060 may offset the phase change and the sign change, and may be matched such that the output ciphertext is matched with the plaintext vector corresponding to the input ciphertext when performing decoding. The output ciphertext in this process may be represented as a modulus value greater than the modulus value of the input ciphertext, and through the above, the decoding precision level is maintained and errors minimized.

Meanwhile, the processor 120 may apply various optimized methods in implementing the bootstrapping process. The optimized method described below is merely exemplary, and it is to be understood that the embodiments described above are not limited by the description above.

In an embodiment, the processor 120 may perform, when performing the blind rotation, processing by decomposing the secret index to a base of smaller units rather than simply decomposing to a binary number. Through the above, a number of necessary rotation operations for obtaining the same result may be reduced, and operation efficiency may be further improved by mixing and applying different bases from one another if necessary.

In an embodiment, the processor 120 may apply, when performing the Slot-to-Coefficient (S2C) transformation, a diagonal scheme or an optimized scheme in levels rather than an existing decomposition scheme. The scheme descried may increase a portion of operation cost, but by providing an advantage of reducing modulus consumption, the overall stability may be improved.

In an embodiment, the processor 120 may set a parameter to secure security even when a hamming weight of the secret key is small. For example, even if the hamming weight is small, security of a sufficient level may be maintained if a suitable parameter is applied.

In an embodiment, the processor 120 may assume that the valid coefficient of the secret key is distributed only in specific sections, and in this case, by reducing a search range of the rotation index to a limited section rather than the whole section, security may be maintained while reducing an operation amount of the blind rotation.

In an embodiment, the processor 120 may select an operation mode taking into consideration the processing delay time, the throughput, and the precision level when performing bootstrapping. Specifically, the processor 120 may support a mode that minimizes delay time according to circumstance or a mode that maximizes the throughput, and respond to various environments through the above.

Meanwhile, the processor 120 may apply, in order to minimize error accumulation in a scale consumption and rescaling process that can generate in the bootstrapping process, a minimization technique which dynamically adjusts a scaling factor and a modulus size. Through the above, the modulus budget may be efficiently managed while maintaining the precision level during the overall operation process.

Moreover, the bootstrapping technique according to the disclosure may be applied in various application services such as inference operation or encrypted database search of a machine learning model. For example, in an environment in which an operation has to be performed without decoding sensitive data of the user, the electronic apparatus 100 of the disclosure may greatly improve real-time processability.

Furthermore, the method according to the disclosure may be applied in even a parallel hardware accelerator environment such as a Graphics Processing Unit (GPU), a Field Programmable Gate Array (FPGA), or a Digital Signal Processor (DSP). Accordingly, the processor 120 may reduce, by performing bootstrapping in parallel in connection with the hardware resources described above, delay time and further improve the throughput.

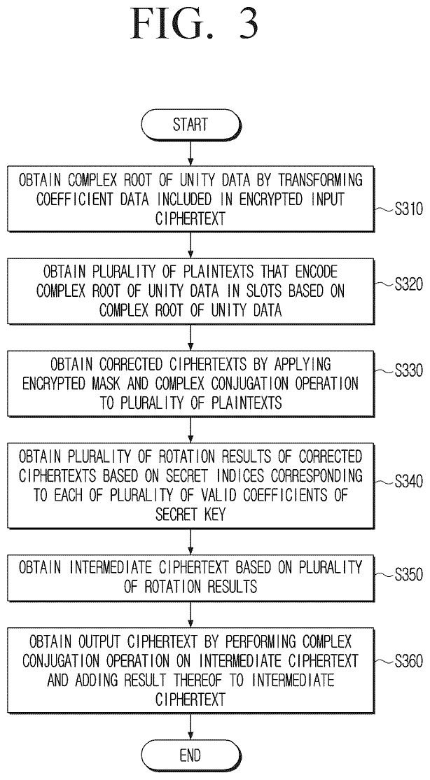

FIG. 3 is a flowchart illustrating a controlling method of the electronic apparatus 100 according to an embodiment of the disclosure.

The electronic apparatus may obtain the complex root of unity data by transforming the coefficient data included in the encrypted input ciphertext (S310). In an embodiment, the electronic apparatus 100 may obtain, after transforming the input ciphertext to slot data, the complex root of unity data stably by increasing the modulus value (modulus raising (ModRaise)).

The electronic apparatus may obtain a plurality of plaintexts for encoding the complex root of unity data in the slots based on the complex root of unity data (S320). In an embodiment, the electronic apparatus 100 may improve accuracy of the output ciphertext by applying the correction efficient to at least one from among the plurality of plaintexts. In an embodiment, the electronic apparatus 100 may have at least one from among the plurality of plaintexts omit the application of the encrypted mask and the complex conjugation operation.

The electronic apparatus may obtain the plurality of rotation results of the corrected ciphertexts based on the secret indices corresponding to each of the plurality of valid coefficients of the secret key (S340). In an embodiment, the electronic apparatus 100 may obtain the plurality of rotation results by performing the blind rotation in parallel based on the secret indices. The blind rotation may refer to as a scheme in which a rotation is performed while the rotation index is in the encrypted state, and the above prevents the position or sign information of the secret key from being exposed to the outside.

In an embodiment, the electronic apparatus 100 may obtain the rotation result by performing at least one from among a sum of the plurality of simple homomorphic rotation operations multiplied by the ciphertexts provided as a part of the blind rotation, and one or more multiplexer-based rotation operations that use a plurality of keys provided as a part of the blind rotation.

The electronic apparatus may obtain the intermediate ciphertext based on the plurality of rotation results (S350). In an embodiment, the electronic apparatus 100 may obtain the intermediate ciphertext by performing the multiplication operation after arranging the plurality of rotation results in the binary tree structure.

The electronic apparatus may obtain the output ciphertext by performing the complex conjugation operation on the intermediate ciphertext and adding the result thereof to the intermediate ciphertext (S360). Here, the output ciphertext may be represented as a modulus value greater than the modulus value of the input ciphertext, and may be decodable with the plaintext vector corresponding to the decoding result of the input ciphertext. In an embodiment, the electronic apparatus 100 may form, after applying the complex conjugation operation to the intermediate ciphertext, the finally stabilized output ciphertext by adding the result thereof back to the intermediate ciphertext.

Meanwhile, a controlling method of the electronic apparatus 100 according to the embodiments described above may be implemented as a program and provided in the electronic apparatus 100. Specifically, a program that includes the controlling method of the electronic apparatus 100 may be stored and provided in a non-transitory computer-readable medium.

Specifically, in terms of a non-transitory computer-readable recording medium that includes a program for executing the controlling method of the electronic apparatus 100, the controlling method of the electronic apparatus 100 may include obtaining the complex root of unity data by transforming the coefficient data included in the encrypted ciphertext, obtaining a plurality of plaintexts that encode the complex root of unity data in slots based on the complex root of unity data, obtaining corrected ciphertexts by applying the encrypted mask and the complex conjugation operation to the plurality of plaintexts, obtaining the plurality of rotation results of the corrected ciphertexts based on the secret indices corresponding to each of the plurality of valid coefficients of the secret key, obtaining the intermediate ciphertext based on the plurality of rotation results, and obtaining an output ciphertext that is represented as a modulus value greater than a modulus value of an input ciphertext by performing a complex conjugation operation on the intermediate ciphertext and adding the result thereof to the intermediate ciphertext, and that is decodable with a plaintext vector corresponding to a decoding result of the input ciphertext.

In the above, the controlling method of the electronic apparatus 100, and the computer-readable recording medium including the program that executes the controlling method of the electronic apparatus 100 have been briefly described, but this is merely to omit redundant descriptions thereof, and the various embodiments of the electronic apparatus 100 may also be applied to the controlling method of the electronic apparatus 100, and the computer-readable recording medium including the program that executes the controlling method of the electronic apparatus 100.

A storage medium readable by a device may be provided in a form of a non-transitory storage medium. Herein, the ‘non-transitory storage medium’ merely means that the device is tangible, and does not include a signal (e.g., electromagnetic waves), and the term does not differentiate data being semi-permanently stored or being temporarily stored in the storage medium. In an example, the ‘non-transitory storage medium’ may include a buffer in which data is temporarily stored.

According to an embodiment, a method according to the various embodiments described in the disclosure may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online (e.g., downloaded or uploaded) through an application store (e.g., PLAYSTORE™) or directly between two user devices (e.g., smartphones). In the case of online distribution, at least a portion of the computer program product (e.g., downloadable app) may be stored at least temporarily in the machine-readable storage medium such as a server of a manufacturer, a server of an application store, or memory 110 of a relay server, or temporarily generated.

Each of the elements (e.g., a module or a program) according to the various embodiments of the disclosure as described above may be configured as a single entity or a plurality of entities, and a portion of sub-elements of the above-mentioned sub-elements may be omitted, or other sub-elements may be further included in the various embodiments. Alternatively or additionally, a portion of the elements (e.g., modules or programs) may be integrated into one entity to perform the same or similar functions performed by the each of the relevant elements prior to integration.

Operations performed by a module, a program, or another element, in accordance with various embodiments, may be executed sequentially, in a parallel, repetitively, or in a heuristic manner, or at least a portion of the operations may be executed in a different order, omitted or a different operation may be added.

Meanwhile, the term “part” or “module” used in the disclosure may include a unit configured with hardware, software, or firmware, and may be used interchangeably with terms such as, for example, and without limitation, logic, logic blocks, components, circuits, or the like. “Part” or “module” may be a component integrally formed or a minimum unit or a part of the component performing one or more functions. For example, a module may be configured as an application-specific integrated circuit (ASIC).

Various embodiments of the disclosure may be implemented with software including instructions stored in a machine-readable storage media (e.g., computer). The machine may call stored instructions from the storage medium, and as a device operable according to the called instructions, may include the electronic apparatus 100 (e.g., electronic apparatus 100 (100)) according to the above-mentioned embodiments.

Based on the instructions being executed by the processor, the processor may directly or using other elements under the control of the processor perform a function corresponding to the instructions. The instructions may include a code generated by a compiler or executed by an interpreter.

While the disclosure has been illustrated and described above with reference to example embodiments thereof, it will be understood that the above-described specific embodiments are intended to be illustrative, not limiting. It will be understood by those skilled in the art that various changes in form and details may be made therein without departing from the true spirit and full scope of the disclosure, including the appended claims and their equivalents.

1. An electronic apparatus, comprising:
memory storing instructions; and
a processor configured to execute the instructions,
wherein the processor is configured to
obtain the complex root of unity data by transforming coefficient data comprised in an encrypted input ciphertext,
obtain a plurality of plaintexts that encode the complex root of unity data in slots based on the complex root of unity data,
obtain corrected ciphertexts by applying at least one encrypted mask and a complex conjugation operation to the plurality of plaintexts,
obtain a plurality of rotation results of the corrected ciphertexts based on secret indices corresponding to each of a plurality of valid coefficients of a secret key,
obtain an intermediate ciphertext based on the plurality of rotation results, and
obtain an output ciphertext that is represented as a modulus value greater than a modulus value of an input ciphertext by performing a complex conjugation operation on the intermediate ciphertext and adding the result thereof to the intermediate ciphertext, and that is decodable with a plaintext vector corresponding to a decoding result of the input ciphertext.

2. The electronic apparatus of claim 1, wherein
the processor is configured to
obtain an output ciphertext by applying a correction coefficient to at least one from among the plurality of plaintexts or at least one from among the corrected ciphertexts.

3. The electronic apparatus of claim 1, wherein
the processor is configured to
obtain an output ciphertext by having at least one from among the plurality of plaintexts omit application of the at least one encrypted mask and the complex conjugation operation.

4. The electronic apparatus of claim 1, wherein
the processor is configured to
transform the input ciphertext to the complex root of unity data, and after encoding the complex root of unity data to plaintext data on a slot basis, increase a modulus value of the plaintext data.

5. The electronic apparatus of claim 1, wherein
the processor is configured to
obtain the plurality of rotation results by performing blind rotation operations in parallel based on the secret indices.

6. The electronic apparatus of claim 5, wherein
the processor is configured to
perform at least one of: a sum of a plurality of simple homomorphic rotation operations multiplied by ciphertexts provided as a part of the blind rotation operations. or and one or more multiplexer-based rotation operations that use a plurality of keys which is provided as a part of the blind rotations.

7. The electronic apparatus of claim 6, wherein
the processor is configured to
perform, based on a range of the secret index being less than or equal to a predetermined threshold value, the simple homomorphic rotation multiplied by ciphertexts, and
perform, based on a range of the secret index exceeding the threshold value, the multiplexer based rotation.

8. The electronic apparatus of claim 1, wherein
the processor is configured to
reduce a number of valid coefficients by using a secret-sparse secret key in a process of obtaining the plurality of rotation results.

9. The electronic apparatus of claim 1, wherein
the processor is configured to
obtain the plurality of rotation results after increasing a modulus value of the input ciphertext.

10. A method for controlling an electronic apparatus, the method comprising:
obtaining the complex root of unity data by transforming coefficient data comprised in an encrypted input ciphertext;
obtaining a plurality of plaintexts that encode the complex root of unity data in slots based on the complex root of unity data;
obtaining corrected ciphertexts by applying at least one encrypted mask and a complex conjugation operation to the plurality of plaintexts;
obtaining a plurality of rotation results of the corrected ciphertexts based on secret indices corresponding to each of a plurality of valid coefficients of a secret key;
obtaining an intermediate ciphertext based on the plurality of rotation results; and
obtaining an output ciphertext that is represented as a modulus value greater than a modulus value of an input ciphertext by performing a complex conjugation operation on the intermediate ciphertext and adding the result thereof to the intermediate ciphertext, and that is decodable with a plaintext vector corresponding to a decoding result of the input ciphertext.

11. A non-transitory computer-readable medium configured to store a program, the program being configured to execute a method for controlling an electronic apparatus, and the method comprising:
obtaining the complex root of unity data by transforming coefficient data comprised in an encrypted input ciphertext;
obtaining a plurality of plaintexts that encode the complex root of unity data in slots based on the complex root of unity data;
obtaining corrected ciphertexts by applying at least one encrypted mask and a complex conjugation operation to the plurality of plaintexts;
obtaining a plurality of rotation results of the corrected ciphertexts based on secret indices corresponding to each of a plurality of valid coefficients of a secret key;
obtaining an intermediate ciphertext based on the plurality of rotation results; and
obtaining an output ciphertext that is represented as a modulus value greater than a modulus value of an input ciphertext by performing a complex conjugation operation on the intermediate ciphertext and adding the result thereof to the intermediate ciphertext, and that is decodable with a plaintext vector corresponding to a decoding result of the input ciphertext.
